(19) United States
(12) Patent Application Publication
(10) Pub. No.: US 2020/0151494 A1
(43) Pub. Date: May 14, 2020

(54) Method, System and Apparatus for Duplicate Images

(71) Applicant: Kristi Ann Clift, Coppell, TX (US)

(72) Inventor: Kristi Ann Clift, Coppell, TX (US)

(21) Appl. No.: 16/190,132

(22) Filed: Nov. 13, 2018

(51) Int. Cl. G06K 9/62; G06F 16/583; G06F 16/11

(52) U.S. Cl. CPC G06K 9/6202; G06F 16/11; G06F 16/5862

(57) ABSTRACT

A method, apparatus and system for managing receiving duplicate images. The method includes receiving an image, comparing the received image to at least one of archived images and previously received images and blocking the image when a match is found between the received image and the at least one of archived images and previously received images.

### FIELD OF THE INVENTION

The disclosure relates to systems, apparatus and methods for identifying the receipt of an image that is a duplicate of another previously archived or received image. More specifically, this disclosure relates to the ability to filter through images being received and automatically identify duplicates.

### BACKGROUND OF THE INVENTION

It is common for individuals to share images. The same images may be received by the same person multiple times from the same sender or different sender. Such duplication wastes memory and is an annoyance. Thus, there is a need for an improved method, apparatus and system for minimizing or illuminating such duplication to avoid memory usage or prevent unnecessary annoyance.

### SUMMARY OF THE INVENTION

Embodiments described herein relate to a method, apparatus and system for managing receiving duplicate images. The method includes receiving an image, comparing the received image to at least one of archived images and previously received images and blocking the image when a match is found between the received image and the at least one of archived images and previously received images.

### BRIEF DESCRIPTION OF DRAWINGS

Reference will now be made to the following drawings:

FIG. 1 is an embodiment illustrating a flow diagram of a method for managing receiving duplicate images;

FIG.2 is a block diagram illustrating an embodiment of a system for managing receiving duplicate images; and

FIG. 3 is an embodiment illustrating an embodiment of a system for managing receiving duplicate images.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

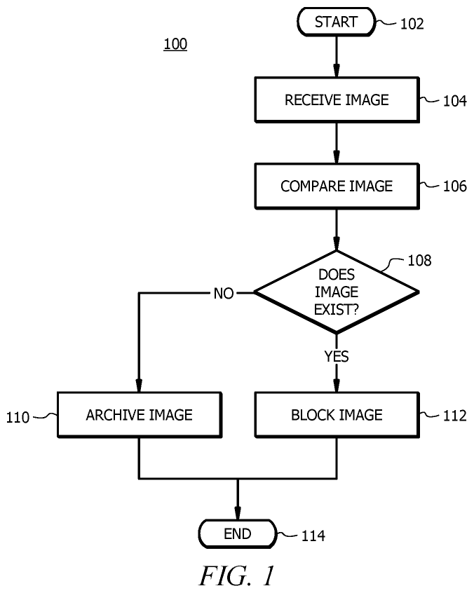

FIG. 1 is an embodiment illustrating a flow diagram of a method 100 for managing receiving duplicate images. The method starts at step 102 and proceeds to step 104. AT step 104, the method 100 receives an image. At step 106 the method 100 compares the received imaged to previously received images or archived images. At step 108, if an image has been previously received or archived, so it exists, then the method 100 proceeds to step 112, wherein the method 100 block the image from being viewed. Otherwise, the method 100 proceeds to step 110, wherein the method 100 allows the user to receive an image and/or archiving the image. The method 100 ends at step 114.

Herein, an image may be a picture, a sequence of pictures, a video and the likes. In one embodiment, the blocking of the viewing of the image 112 may include rejecting the image, deleting the image, archiving the image in a designated folder, and/or following a system setting that determines the action taken on received images that are duplicates. Similarly, archiving the image at step 110 may allow the receipt of an image, may actually archive the image, and/or may allow trigger an action specified in the system setting.

The method 100 may be executed by a processor as code on a mobile device, cellular phone, tablet, watch and/or personal computer. In another embodiment, the method 100 is a downloadable application on mobile device, cellular phone, tablet, watch and/or personal computer. In yet another embodiment, the method 100 may be enabled or disabled by a user. The image blocker method 100 the user's setting synchronizes on all the user's devices. In one embodiment, the blocking of an image synchronized on all the user's devices. In yet another embodiment, the blocked images are archived in a designated location.

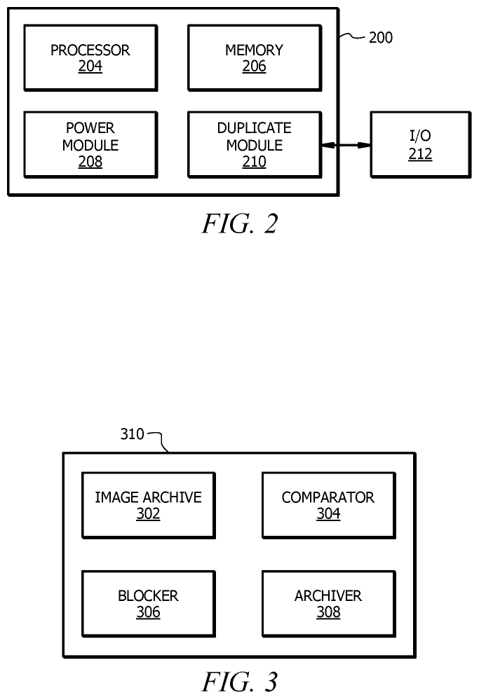

FIG.2 is a block diagram illustrating an embodiment of a system for managing receiving duplicate images. The system 200 includes a processor 204, memory a/computer readable medium 206, power module 208, duplicate module 210 and an input/output (I/O) module 212.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Any combination of one or more computer readable media may be utilized. The computer readable media may be a computer readable signal medium, any type of memory or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction execution system, apparatus, or device.

Computer program code for carrying out operations utilizing a processor for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C#, Pascal, *Arduino. Additionally, operations can be carried out using any variety of compiler available.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

FIG. 3 is an embodiment illustrating an embodiment of an apparatus 300 for managing receiving duplicate images. The apparatus 300 comprises an image archive 302, a comparator 304, a blocker 306 and an archiver 308. The comparator 304 determines if a received image is a duplicate of an image archive in the image archive 302 or a previously received image. Such comparison may utilize metadata, RGB values, pixel values and average pixel values to perform the comparisons.

In one embodiment, the apparatus 300 is a device that connects or coupled to a mobile device, cellular phone, tablet, watch and/or personal computer. The apparatus 300 may incorporate a computer readable medium within the device or utilize one on the device the apparatus 300 is connected or coupled to. In one embodiment, the apparatus 300 couples to a device with a port, USB, HDMI, etc.

In one embodiment, the blocking of the viewing of the image 112 may include rejecting the image, deleting the image, archiving the image in a designated folder, and/or following a system setting that determines the action taken on received images that are duplicates. Similarly, archiving the image at step 110 may allow the receipt of an image, may actually archive the image, and/or may allow trigger an action specified in the system setting.

In another embodiment, the apparatus 300 is capable of utilizing artificial intelligence to learn a user's learned behavior. For example, the apparatus 300 may learn that a user enjoys receiving images in black and white. In such a scenario, the apparatus would set itself to allow the receipt of duplicate images in different colors. In other circumstances, the apparatus 300 may determine that the user consider the same image with the different colors duplicate. As such, the apparatus 300 would block such images in such scenarios.

In one embodiment, a device may take a burst of images. In such case, the method 300 would analyze the burst of images for duplicates. Duplicate images may be deleted automatically sent to a folder or archived in a folder/directory based on elections in the settings.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

What is claimed is:

1. A method for managing receiving duplicate images, the method comprising the steps of:
receiving an image;
comparing the received image to at least one of archived images and previously received images; and
blocking the image when a match is found between the received image and the at least one of archived images and previously received images.

2. The method of claim 1 further comprising archiving the image when a match is not found between the received image and the at least one of archived images and previously received images.

3. The method of claim 1, wherein the method is executed by a processor on a mobile device, cellular phone, tablet, watch or personal computer.

4. The method of claim 3, wherein the method is an application on the mobile device, cellular phone, tablet, watch or personal computer.

5. The method of claim 1, wherein the method utilizes metadata to perform the comparisons.

6. The method of claim 1, wherein the method utilizes at least one of RGB values, pixel values and average pixel values to perform the comparisons.

7. The method of claim 1, wherein the method can be enabled or disabled by a user.

8. The method of claim 7, wherein the user's setting synchronizes on all the user's devices.

9. The method of claim 7, wherein the blocking of an image synchronized on all the user's devices.

10. The method of claim 1, wherein the blocked images are archived in a designated location.

11. A system for managing receiving duplicate images, the system comprising:
a processor adapted to execute computer instruction;
input/out module for receiving images;
a computer readable medium for archiving at least one of computer instructions and images;
a duplicate module coupled to the processor, input/output module, and the computer readable medium, wherein the duplicate module compares at least one received image to at least one of archived images and previously received images; and
blocking the image when a match is found between the received image and the at least one of archived images and previously received images.

12. The system of claim 11, wherein the duplicate module further archives the image when a match is not found between the received image and the at least one of archived images and previously received images.

13. The system of claim 11, wherein the system is a mobile device, cellular phone, tablet, watch or personal computer.

14. The system of claim 13, wherein the duplicate module in an application on the mobile device, cellular phone, tablet, watch or personal computer.

15. The system of claim 11, wherein the duplicate module utilizes metadata to perform the comparisons.

16. The system of claim 11, wherein the duplicate module utilizes at least one of RGB values, pixel values and average pixel values to perform the comparisons.

17. The system of claim 11, wherein the duplicate module can be enabled or disabled by a user.

18. The system of claim 17, wherein the user's setting synchronizes on all the user's devices.

19. The system of claim 17, wherein the blocking of an image synchronized on all the user's devices.

20. The system of claim 11, wherein the blocked images are archived in a designated location.

21. An apparatus for managing receiving duplicate images, the apparatus comprising:
an image archive for storing images;
a comparator coupled to the image archiver and adapted to compare at least one received image to at least one of a previously received image and an archived image archived on the image archine and determining if the received image is a duplicate image; and
a blocker coupled to the comparator, wherein the blocker blocks a user from viewing a duplicate image.

22. The apparatus of claim 21 further comprising an archiver adapted to archives the image when a match is not found between the received image and the at least one of archived images and previously received images.

23. The apparatus of claim 21, wherein the apparatus is coupled to a mobile device, cellular phone, tablet, watch or personal computer.

24. The apparatus of claim 23, wherein the apparatus is coupled to a mobile device, cellular phone, tablet, watch or personal computer comprising an application.

25. The apparatus of claim 21, wherein the comparator utilizes metadata to perform the comparisons.

26. The apparatus of claim 21, wherein the comparator utilizes at least one of RGB values, pixel values and average pixel values to perform the comparisons.

27. The apparatus of claim 21, wherein the blocker can be enabled or disabled by a user.

28. The apparatus of claim 27, wherein the user's setting synchronizes on all the user's devices.

29. The apparatus of claim 27, wherein the blocking of an image synchronized on all the user's devices.

30. The apparatus of claim 21, wherein the blocked images are archived in a designated location.

31. A method for managing duplicate images, the method comprising the steps of:
capturing two or more images from a burst image capture;
comparing the images captured in the burst image capture for duplication; and
blocking the image when a match is found by at least one of deleting the image, sending the duplicates to a predetermined location, and archiving the image to a location identified in the setting.
